(19) United States
(12) Patent Application Publication
(10) Pub. No.: US 2016/0267144 A1
(43) Pub. Date: Sep. 15, 2016

(54) COLLECTING AND GENERATING GEO-TAGGED SOCIAL MEDIA DATA THROUGH A NETWORK ROUTER INTERFACE

(71) Applicant: WeLink, Inc., San Jose, CA (US)

(72) Inventor: Karthik Mavaneethan Manimaran, San Jose, CA (US)

(21) Appl. No.: 14/656,252

(22) Filed: Mar. 12, 2015

(51) Int. Cl. G06F 17/30; H04L 29/06

(52) U.S. Cl. CPC G06F 17/30525; G06F 17/30551; G06F 17/30628; G06F 17/30876; H04L 63/0876; H04L 63/102; H04L 65/403

(57) ABSTRACT

Embodiments of an information management system and related methods are disclosed. In some embodiments, the system joins social media data received from social media sources and router data received from network routers based on information identifying social media users, and organizes the joined data by device-specific information. The system can enhance the social media data, including those social media contents having no geotags, using location information associated with network routers or geotags associated with some of the social media contents. The system can also analyze the combined, organized data to glean insight into a user's social activities, along a timeline, across a set of locations, with respect to a group of other users, and so on.

### TECHNICAL FIELD

The present application is related to processing social media and, in particular, to enhancing social media data with additional information.

### BACKGROUND

Communication is shifting from traditional platforms and media—such as phone and paper—to digital media. Among the notable digital media are email, blogs, and social media networks. The social data networks are operated by companies including Twitter, Instagram, Facebook, Google Plus, YouTube, Flickr, Picasa, Foursquare, Nextdoor, Pinterest, Yelp, 500px, Photobucket, Panaromio, Meetup, Eventbrite, Dailymotion, Viddy, SoundCloud, YikYak, Snapchat, Whisper, Secret, TripAdvisor, Expedia, Travelocity, etc. Social media data has quickly attracted the attention of various businesses, which analyze such data to extract behavioral patterns and other useful information regarding social media users. Given the amount of interest in social media data, it would be useful to enhance such data to enable a more comprehensive and accurate analysis.

### BRIEF DESCRIPTION OF THE DRAWINGS

Various embodiments are disclosed in the following detailed description and accompanying drawings.

FIG. 1 is an environment diagram illustrating an example environment in which an information management system disclosed in the present application can operate.

FIG. 2 illustrates example components of the information management system.

FIG. 3 illustrates example social media data.

FIG. 4A illustrates example router data produced by a network router.

FIG. 4B illustrates additional example router data produced by a network.

FIG. 5 illustrates an example process performed by the information management system of integrating social media data and router data, and organizing the integrated data.

FIG. 6 illustrates an example process performed by the information management system of enhancing social media data with location information.

FIG. 7 is a high-level block diagram showing an example architecture of a computer, which may represent any electronic device, any server, or any node within a cloud service as described herein.

### DETAILED DESCRIPTION

Location has been an important dimension of social media data. Social media users may volunteer location information. They may do so by specifying locations in their social media postings, by turning on location services offered by their computing devices and the social media to have location data automatically attached to social media contents they have produced, and so on. However, location information may not be available otherwise in social media data. This application discloses an information management system and related methods that enhance social media data with additional location information by collecting and analyzing data from network routers.

The following is a detailed description of exemplary embodiments to illustrate the principles of the invention. The embodiments are provided to illustrate aspects of the invention, but the invention is not limited to any embodiment. The scope of the invention encompasses numerous alternatives, modifications, and the equivalent.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

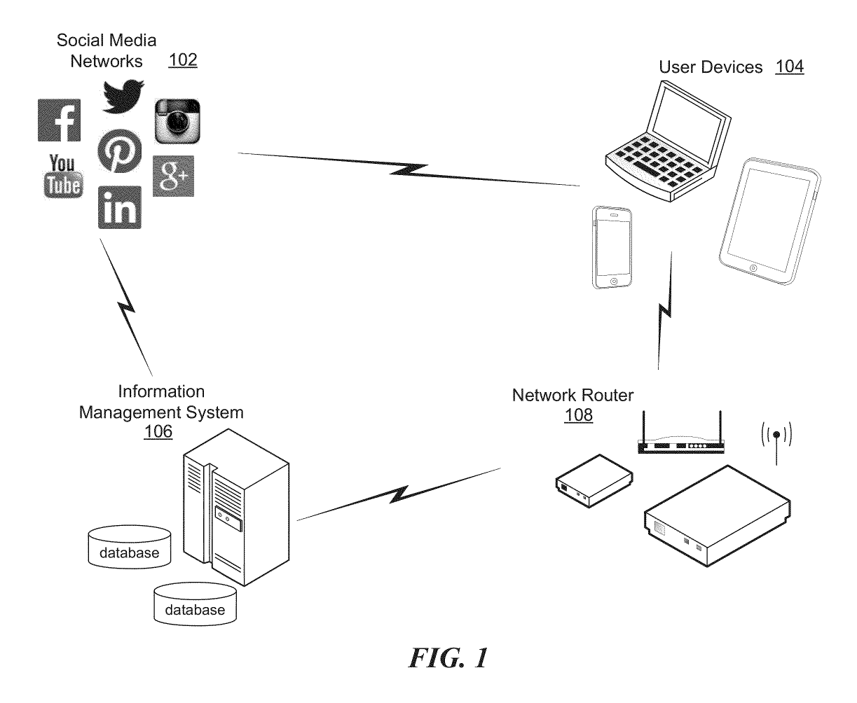

FIG. 1 is an environment diagram illustrating an example environment in which the information management system can operate. In some embodiments, the information management system 106 comprises servers and databases that possess sufficient data storage and processing power as well as networking and communication capabilities. In general, users of social media networks 102 produce social media contents through user devices 104, such as mobile phones, tablets, laptop computers, desktop computers, and wearable devices. Operators of the social media networks 102 include Twitter, Instagram, Facebook, Google Plus, YouTube, Flickr, Picasa, Foursquare, Nextdoor, Pinterest, Yelp, 500px, Photobucket, Panaromio, Meetup, Eventbrite, Dailymotion, Viddy, Soundcloud, YikYak, Snapchat, Whisper, Secret, TripAdvisor, Expedia, Travelocity, etc. The user devices 104 transmit the social media contents to the social media networks 102 across computer networks, such as the Internet. The information management system 106 receives social media contents and metadata from the social media networks 102, social media plugins, or social media data collectors which aggregate social media data streams, such as Firehose, through computer networks. Social media metadata can include information identifying a social media user, the user's device, the user's location, and so on.

In some embodiments, the system 106 also receives various data from a network router 108 to which computing devices are connected. The type of network managed by the network router 108 includes a wireless network as well as a wired network. The network router 108 controls network traffic into and out of the network and has access to all data produced and received by the connected devices. Depending on security restrictions, the network router 108 can make available information identifying the network router, a connected device, a user using the connected device, and so on. The information management system 106 can be connected to that network or communicate with the network router 108 through another network, such as the Internet. By correlating data received from social media data sources and data received from network routers, the information management system 106 can infer various attributes of social media data, including locations from which certain social media contents were created and, thus, locations of social media users who created those social media contents. By virtue of this feature, the information management system 106 enriches the social media data for use by various businesses.

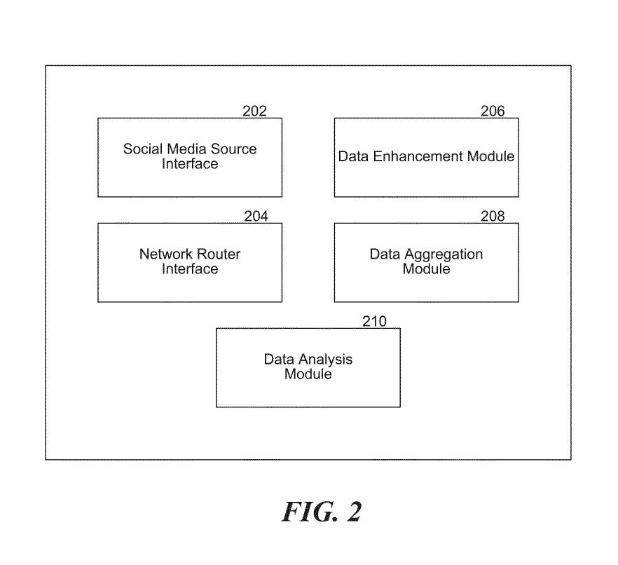

FIG. 2 illustrates example components of the information management system. In some embodiments, the system includes a social media source interface 202, a data enhancement module 206, a data aggregation module 208, a network router interface 204, and a data analysis module 210. The social media source interface 202 manages interactions with social media sources, including social media networks, social media plugins, and social media data collectors. The network router interface 204 manages interactions with network routers, each allowing devices to connect to it wirelessly. The data aggregation module 208 aggregates the router data and the social media data, and organizes the aggregated data for individual social media users. The data enhancement module 206 enriches the social media data based on new relations established from the combination with the router data. The data analysis module 210 dissects the available data to extract business intelligence on user's social activities.

In some embodiments, the social media source interface 202 obtains social media contents and metadata from the social media sources through a published application programming interface (API) or any other specified access mechanism. For example, Facebook makes data available through an API, while Firehose delivers data in a supported format, such as JSON. Social media data can also be obtained by crawling social media websites. The retrieval of the social media data can take place on a daily basis, upon a specific request from an advertising platform, or according to any other schedule.

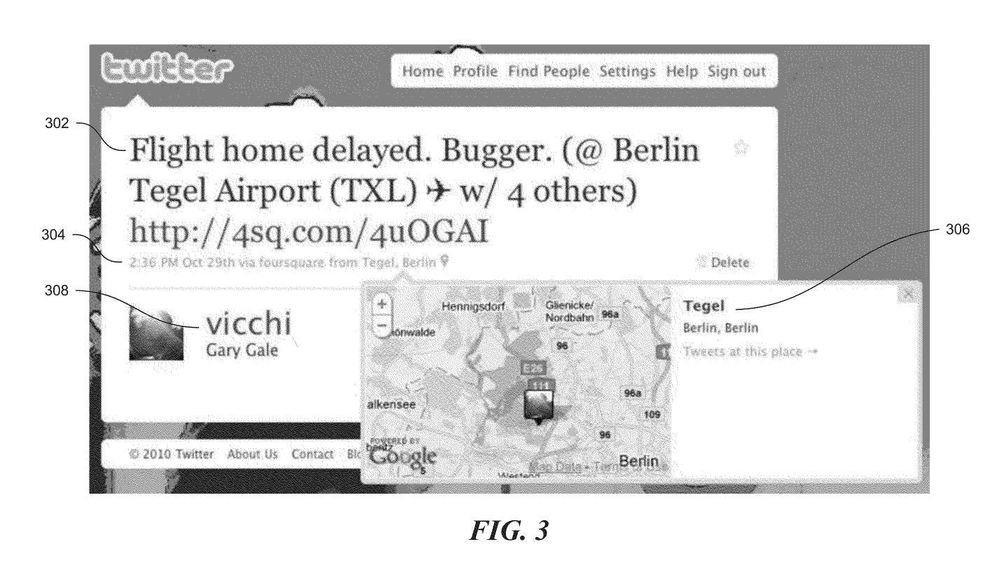

FIG. 3 illustrates example social media data. The data corresponds to a tweet. The tweet includes a message 302, which is normally considered as the content of the tweet and includes text but could include other types of data, such as images and videos. The content may be dissected to deduce various types of information regarding the social media user or the author of the message. For example, the word “flight” may indicate that the user is travelling, the word “bugger” may indicate frustration, the words “Tegel Airport” and “(TXL)” may indicate the user's current or recent location, and the uniform resource location (URL) “http://4sq.com/4uOGAI” and the referenced content may indicate additional interests of the user. The tweet also includes author information 308 indicating who composed and sent the message, time information 304 indicating when the message was sent, and location information 306 indicating where the message was sent from. Such information can be considered part of the content but is more often considered part of the metadata of the tweet. Not all types of metadata may exist for a tweet. For example, when a user does not turn on the geotag feature, the location information would not be stored with the content. On the other hand, metadata other than user, location, and time information may be stored with the tweet depending on the collector of the social media data. For example, together with the message, Firehose may make available language information indicating in which language the message was written and Klout information indicating the user's influence ranking. The content and the metadata can both be analyzed to determine attributes and activities of the author.

Many other types of social media data also include location information. As another example, Instagram offers a feature that maps the photos in a user's account to locations determined by a GPS system, for example, shows the photos on a map, and allows other users to browse the photos by mapped locations or geotags. The location of a photo determined this way typically coincides with the user's location. Therefore, such geotags can also be used to analyze attributes and activities of the user.

In some embodiments, the network router interface 204 obtains router data from the network router. The network router interface 204 can connect to the network router and obtain data through APIs provided by the network router. In cases where an API isn't available, configuration changes can be made to the network interfaces of the network router to provide data for custom network protocol listeners, such as those offered by Syslog, Netflow, etc., and the data is subsequently made available to the network router interface 204. The data thus collected typically contains static information regarding the devices connected to the network router, such as their IP addresses and MAC addresses. The data can also contain dynamic information that is collected the connected devices transmit data through the network router. Such information includes URLs and ports of visited websites and timestamps of the visits, which enables router data to be combined with social media data. The retrieval of the router data can take place on a daily basis, upon a specific request from an advertising platform, or according to any other schedule.

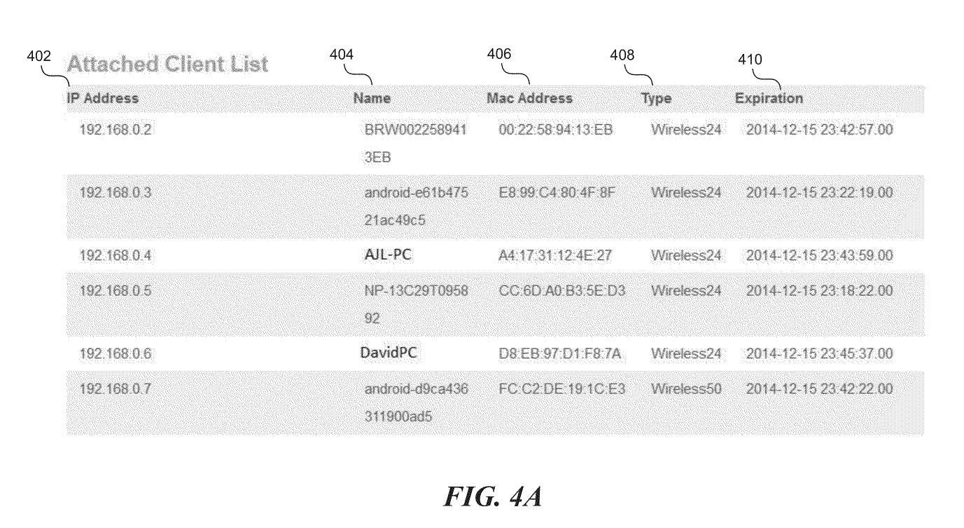

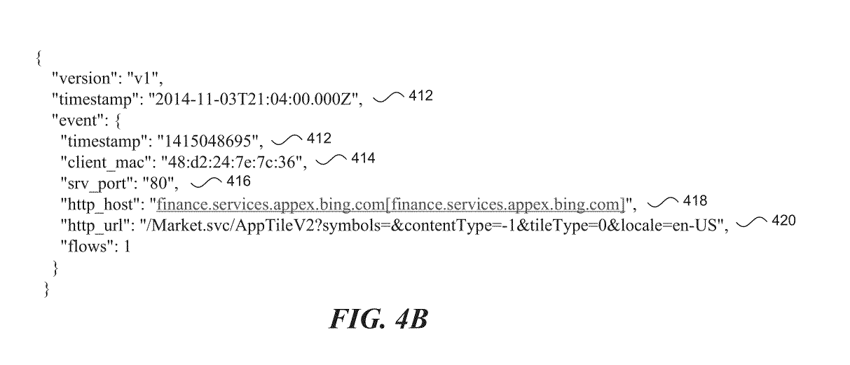

FIG. 4A illustrates example router data produced by a network router. The data shows, for each device connected to the network router, the IP address 402, the name 404, the MAC address 406, the type of network interface 408, and a timestamp 410 associated with the connection. The IP address 402 is assigned by the network router, while the MAC address is a permanent and unique identifier of the device regardless of where the device is located or to which network router the device is connected. In some instances, a MAC address can be used to obtain the physical location of the device, through services by Skyhook Wireless, for example. In addition, the router data can include information of the network router, such as its own MAC address and other configuration settings.

FIG. 4B illustrates additional example router data produced by a network router. This router data corresponds to a website visit made by a connected device. This router data includes a MAC address 414 that is used to associate this data with a particular device. It also includes a two-part timestamp 412 and a three-part website address consisting of a host address 418, a path 420, and a port 416. Every time the user of a connected device makes a social media communication and thus the device makes a visit to the social media network, such data can be recorded and used to identify the social media communication from the collected social media data.

In some embodiments, the data aggregation module 208 joins social media data received from social media sources and router data received from network routers based mainly on timing information, which is generally available at a millisecond granularity. For a specific device, when the router data specifies that the device visits one of the social media websites at certain times or during a time range, the contents posted to that social media website at those times or within the time range would be associated with the device. Specifically, the URLs included in the router data can be matched with the names of the social media networks by any known text comparison techniques. The timestamps included in the router data can similarly be matched with the timestamps included in the social media data by any known timing data comparison techniques, but additional factors are taken into consideration.

In some embodiments, the data aggregation module 208 estimates the delay from when a social media communication is transmitted by the device to when the social media communication is published on a social media website by a sampling over networks of varying statistics. The data aggregation module 208 can obtain a single distribution or fit the data into a known distribution and use a summary statistic, such as the mean, to estimate the delay. The data aggregation module 208 can also determine different distributions for different types of networks and apply the summary statistic for the distribution corresponding to the network router.

In some embodiments, a timestamp in the router data can be matched with multiple timestamps in the social media data, which correspond to multiple social media communications published almost simultaneously, or a timestamp in the social media data can be matched with multiple timestamps in the router data, which correspond to multiple devices that are connected to the same network router and transmitted data to the same social media network almost simultaneously. In some embodiments, the data aggregation module 208 resolves either situation by social profiling. Initially, some of the social media communications with matching timestamps can self-eliminate based on their geotags. Next, the data aggregation module 208 identifies, for the each of the social media communications with a matching timestamp, the author's social circle including family, friends, followers, who are users of the same social media network from additional social media data. The data aggregation module 208 then determines, for each of the devices connected to a network router and having a matching timestamp, whether the list of visited websites refer to social media accounts of those in any of the determined social circles or otherwise reflect an affinity to the social circle. Depending on the determination results, the data aggregation module 208 can assign different weights to different matches between a social media communication and a device connected to a network router. Such weights can be adjusted over time as more data is accumulated for each social media user and each connected device. As a result of the matches, information in the social media data, such as a user or profile ID, a location, and certain keywords, can be linked to a MAC address included in the router data.

In some embodiments, from the aggregated data, the data aggregation module 208 establishes an account corresponding to a social media user under each MAC address. The data aggregation module 208 generates a substantially unique hash for the MAC address that is difficult to revert, using a cryptographic hash function, for example. The data aggregation module 208 then stores the hash instead of the MAC address for the account, to ensure security of the MAC address and, thus, anonymity of the social media user. The data aggregation module 208 also adds all the data related to this MAC address, such as an IP address or a social media profile ID, to the account under the MAC address. In this fashion, the data aggregation module 208 reviews each MAC address contained in the router data or the aggregated data, computes a hash for the MAC address, determines whether an account is already established under that MAC address, and creates a new account upon a negative determination.

In some embodiments, the data aggregation module 208 creates an index for one or more types of information stored under the accounts to facilitate targeted access to the accounts. Through such data collection and combination, social media contents published by a user on different social media networks, at different times, or when the user's device is connected to different routers and, thus, when the user is in different locations, are aggregated. The resulting data therefore offers a wealth of information allowing complex, detailed analysis of users' social activities.

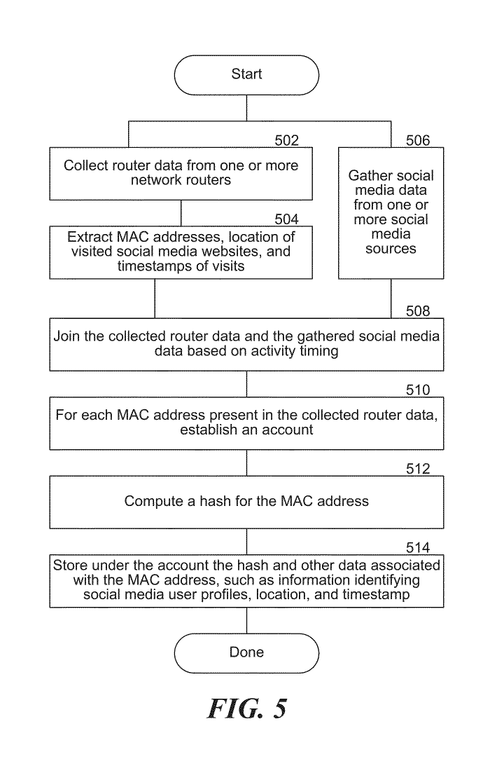

FIG. 5 illustrates an example process performed by the information management system of integrating social media data and router data and organizing the integrated data. In step 502, the system collects router data form network routers. For each network router, the router data includes data regarding the network router, the devices connected to the network router, or the users of the devices. In step 504, the system extracts different pieces of information from the router data, including the MAC address of a device, URLS of websites visited by the device, and timestamps of the visits. In step 506, the system also gathers social media contents and metadata from social media data sources. The system can crawl social media websites, directly access social media networks through published APIs, or receive social media data from data collectors, such as Firehose. For each social media posting, the corresponding metadata can include the author's profile ID at a social media network, the location of the device used to transmit the social media content, the time of content publication, etc. The collection of the router data and the gathering of the social media data can be performed simultaneously or according to separate schedules. In step 508, the system joins the router data and the social media data by matching the URLs of visited websites and the timestamps of the visits with the URLs of the social media websites and the timestamps of social media activities, respectively. As a result, a device with a particular MAC address can be linked to a social media user and social media contents published by the user.

In step 510, the system creates an account for each MAC address included in the aggregated data. In step 512, the system computes a hash for the MAC address that is substantially unique and difficult to revert. In step 514, the system stores in the account the computed hash and any other data linked to the MAC address, such as IP addresses, social media user IDs, social media data associated with different times and locations, etc. The system can also include in the account those social media contents transmitted by the device. In this manner, the system organizes the combination of the social media data and the router data by user devices based on MAC addresses, while maintaining a high degree of security of user-specific information.

In some embodiments, as one important attribute of social activities is location, the data enhancement module 206 enriches the received social media data by associating as much location information as possible with the social media contents. The router data from a network router is helpful for this purpose because the devices connected to the network router tend to be located near the network router.

In some embodiments, since the router data from a network router can contain or be used to obtain a location of the network router and, thus, an approximate location of the devices connected to it, the data enhancement module 206 can directly associate any social media data that can be combined with the router data with that location. For example, when a network router is located in a stadium and a user's laptop is connected to the network router during a specific morning, the laptop and the user would also be deemed to be located in the stadium that morning. As a result, all the social media communications made by the user that specific morning that are not yet associated with any geotag would be associated with a geotag specifying the stadium.

In some embodiments, since certain social media content can be tagged with location information, when that social media content and separate social media content can be combined with router data from the same network router, the data enhancement module 206 can also tag the separate social media content with the location information. For example, when a social blog posted by a first user through a cellular phone has a geotag of Boston and a merchant review posed by a second user through a tablet computer does not have a geotag, and when both the cellular phone and the tablet computer are connected to the same network router a specific afternoon, the tablet computer and the second user can also be deemed to be located in Boston. As a result, all the other social media communications made by the second user that specific afternoon that are not yet associated with any geotag would be associated with a geotag specifying Boston.

In some embodiments, the data enhancement module 206 enhances or confirms existing location tags associated with social media contents. For certain social media content, multiple sources of location information can be available. In one scenario, the social media content produced by a user through a computing device can have a geotag, which may indicate merely the city where the computing device and the user are located. When it is determined that the computing device is connected to a network router having a known location that is as specific as describing the latitude and the longitude, the geotag can be refined to include the latitude and the longitude. In another scenario, when the social media contents from multiple computing devices connected to the same network router all have similar geotags and yet the network router is associated with a completely different location, the data enhancement module 206 can update the location associated with the network router to be consistent with those geotags. The updated location can be assigned to social media contents transmitted by devices subsequently connected to the network router.

In some embodiments, by taking into consideration the reliability of each source of location information, the data enhancement module 206 can determine a location for certain social media content and assign a confidence score to the determined location. For example, when the geotag is automatically determined by the GPS service offered by the computing device, it may be highly reliable, while when the location of a network router is determined by “wardriving” sort of manual efforts, it can be more prone to mistakes. The data enhancement module 206 can weigh the different location data accordingly and determine the location and confidence score to be associated with the social media content based on the weighting.

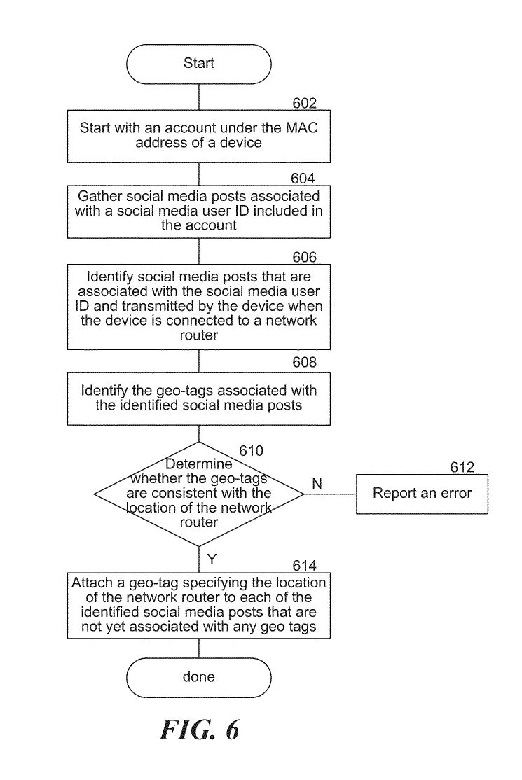

FIG. 6 illustrates an example process performed by the information management system of enhancing social media data with location information. In step 602, the system starts with an account for a MAC address that includes a social media user ID, as discussed above. The account can also contain aggregated social media data and router data associated with a device having the MAC address. In step 604, the system gathers social media data that are associated with the social media user ID. In step 606, the system identifies the social media associated with the social media user ID that were also transmitted by the device when the device was connected to a specific router. For example, from the router data, the system can determine a timespan during which the device was connected to the specific router and identify all the social media data associated with timestamps that fall within the timespan. Depending on the social media networks, the user's preferences, or other factors, not all the identified social media data may be associated with geotags or even the same geotags. In step 608, the system extracts any geotags associated with the identified social media data. In step 610, the system compares the extracted geotags with a known location of the network router. When the geotags are consistent with the known location, in step 614, the system then attaches a geotag to those identified social media data that are not yet associated with geotags. The content of the geo tag can vary. For example, it can be the most specific of the location information associated with the identified social media data or the network router. When the geotags are do not converge or are not consistent with the known location of the network router, in step 612, the system reports an error alerting potential frauds in the creation or publication of the geotags, or the determination of the network router location.

In some embodiments, the data analysis module 210 can filter the available data to limit analysis to one or more dimensions, sometimes based on client needs or interests. The data analysis module 210 can further apply one or more known data processing techniques, such as various classification and learning methods, on the analyzed data, which may be in text, image, video, or other formats, to characterize or predict activities of social media users. As one example, a personalized directory service may be interested in knowing a set of locations frequented by a social media user. The data analysis module 210 can then focus on the available data related to the social media user and categorize the list of locations associated with the social media user. As a second example, it may be helpful to understand how often or likely that a location has repeat visitors. In this case, the location may be a hotel in which a network router operates, and the client to whom the analysis would be helpful may be the owner of the hotel. The data analysis module 210 can then filter out the available data that is unrelated to the network router and extrapolate the pattern of device connections from the remaining available data. As a third example, a clothing store may want to determine the advertising value of a social media user based on the locations visited by the user. The data analysis module 210 can then again limit the analysis to the available data related to the social media user, and correlate such available data with data in an external database which describes individual locations, such as the nature of the business and the average price of merchandize in the store. In general, the data generated by the data analysis module 210 can be communicated to a client of the system via a graphical user interface across a network immediately in response to a request from the client or according to a predetermined schedule.

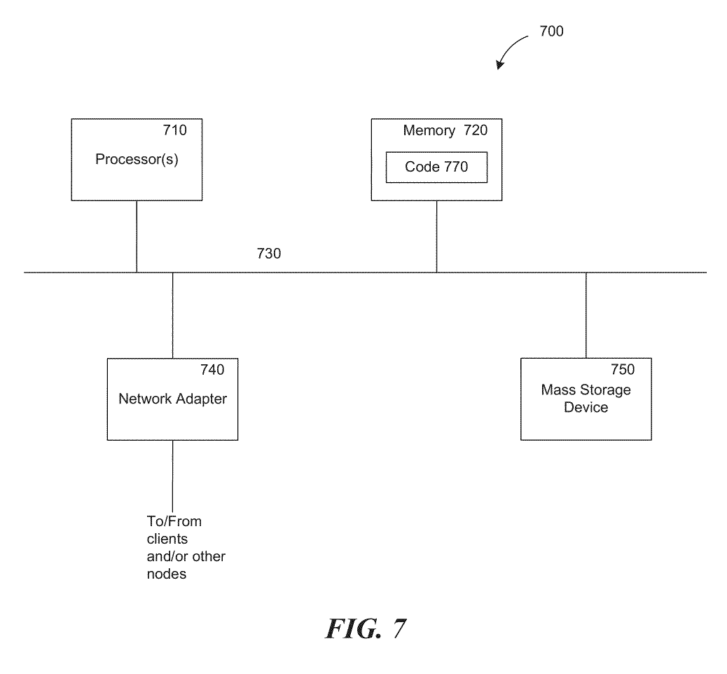

FIG. 7 contains a high-level block diagram showing an example architecture of a computer, which may represent any electronic device, such as a mobile device or a server, including any node within a cloud service as described herein, such as may implement the operations described above. The computer 700 includes one or more processors 710 and memory 720 coupled to an interconnect 730. The interconnect 730 shown in FIG. 7 is an abstraction that represents any one or more separate physical buses, point-to-point connections, or both, connected by appropriate bridges, adapters, or controllers. The interconnect 730, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), an IIC (I2C) bus, or an Institute of Electrical and Electronics Engineers (IEEE) standard 1394 bus, also called “Firewire”.

The processor(s) 710 is/are the central processing unit (CPU) of the computer 700 and, thus, control the overall operation of the computer 700. In certain embodiments, the processor(s) 710 accomplish this by executing software or firmware stored in memory 720. The processor(s) 710 may be, or may include, one or more programmable general-purpose or special-purpose microprocessors, digital signal processors (DSPs), programmable controllers, application specific integrated circuits (ASICs), programmable logic devices (PLDs), field-programmable gate arrays (FPGAs), trusted platform modules (TPMs), or a combination of such or similar devices.

The memory 720 is or includes the main memory of the computer 700. The memory 720 represents any form of random access memory (RAM), read-only memory (ROM), flash memory, or the like, or a combination of such devices. In use, the memory 720 may contain code 770 containing instructions according to the techniques disclosed herein.

Also connected to the processor(s) 710 through the interconnect 730 are a network adapter 740 and a mass storage device 750. The network adapter 740 provides the computer 700 with the ability to communicate with remote devices over a network and may be, for example, an Ethernet adapter. The network adapter 740 may also provide the computer 700 with the ability to communicate with other computers.

The code 770 stored in memory 720 may be implemented as software and/or firmware to program the processor(s) 710 to carry out actions described above. In certain embodiments, such software or firmware may be initially provided to the computer 700 by downloading it from a remote system through the computer 700 (e.g., via network adapter 740).

### CONCLUSION

The techniques introduced herein can be implemented by, for example, programmable circuitry (e.g., one or more microprocessors) programmed with software and/or firmware, or entirely in special-purpose hardwired circuitry, or in a combination of such forms. Software or firmware used for implementing the techniques introduced here may be stored on a machine-readable storage medium and may be executed by one or more general-purpose or special-purpose programmable microprocessors.

In addition to the above mentioned examples, various other modifications and alterations of the invention may be made without departing from the invention. Accordingly, the above disclosure is not to be considered as limiting, and the appended claims are to be interpreted as encompassing the true spirit and the entire scope of the invention.

The various embodiments are described above with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

A “machine-readable storage medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc.

These computer program instructions may also be stored in a computer-readable medium that can direct a computer, other programmable data processing apparatus, or other devices to function in a particular manner, such that the instructions stored in the computer-readable medium produce an article of manufacture, including instructions which implement the function/act specified in the flowchart and/or block diagram block or blocks.

The computer program instructions may also be loaded onto a computer, other programmable data processing apparatuses, or other devices to cause a series of operational steps to be performed on the computer, other programmable apparatuses, or other devices to produce a computer-implemented process, such that the instructions which execute on the computer or other programmable apparatus provide processes for implementing the functions/acts specified in the flowchart and/or block diagram block or blocks.

The aforementioned flowchart and diagrams illustrate the architecture, functionality, and operation of possible implementations of systems, methods, and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special-purpose hardware-based systems that perform the specified functions or acts or by combinations of special-purpose hardware and computer instructions.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some, but not necessarily all, embodiments of the inventions.

It is to be understood that the phraseology and terminology employed herein are not to be construed as limiting and are for descriptive purpose only.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

1. A computer-performed method of enhancing social media contents, comprising:
receiving, by a processor, from a content provider social media contents created by a plurality of users,
wherein a first social media content created by a first of the plurality of users is tagged with a user ID, a first timestamp, but not a physical location, and
wherein a second social media content is tagged with a second timestamp and a specific physical location;
receiving, by a processor, from a router for a network a MAC address of a first device connected to the router, a first website address of a first website visited in a first visit by the first device, and a third timestamp for the first visit, and a second website address of the first website visited in a second visit by a second device connected to the router and a fourth timestamp for the second visit by the second device;
when the first website belongs to one of a predetermined list of social networks, when the first timestamp matches the third timestamp, and when the second timestamp matches the fourth timestamp, tagging the first social media content with the specific physical location; and
creating an account including the MAC address, and the first social media content with corresponding tags in a database.

2. A computer-performed method of enhancing social media contents, comprising:
receiving, by a processor, from a first router for a computer network, first data and second data regarding communication with a first content provider by one or more devices connected to the first router;
receiving, by a processor, from a data provider a first content including first details originally published by a second content provider that is not tagged with a physical location, and a second content including second details originally published by the second content provider that is tagged with a first physical location;
determining whether the first data matches at least in part with the first content and whether the second data matches at least in part with the second content; and
when the determining results indicate matches, tagging the first details with the first physical location.

3. The computer-performed method of claim 2,
wherein the first data includes a device ID, a first website address associated with the first content provider, and a first timestamp for visiting the first website,
wherein the second data includes a second website address associated with the first content provider, and a second timestamp for visiting the second website,
wherein the first content includes the first details tagged with a first user ID, a third timestamp, but no physical location,
wherein the second content includes the second details tagged with a fourth timestamp and the first physical location, and
wherein the determining includes determining whether the first content provider is identical to the second content provider, whether the first timestamp matches the third timestamp, and whether the second timestamp matches the fourth timestamp.

4. The computer-implemented method of claim 3, wherein the device ID is a MAC address.

5. The computer-implemented method of claim 3, wherein the first data is associated with a first device connected to the first router, and the second data is associated with a second device connected to the first router different from the first device.

6. The computer-implemented method of claim 3, wherein the first data and the second data are associated with the same device connected to the first router.

7. The computer-implemented method of claim 6, wherein the device is a mobile device.

8. The computer-implemented method of claim 3, further comprising creating an account including the device ID, and the first content including corresponding tags in a database.

9. The computer-implemented method of claim 8, further comprising:
computing a substantially unique hash for the device ID; and
including the hash in the account instead of the device ID.

10. The computer-implemented method of claim 8, further comprising:
receiving from the first router third data regarding communication with a third content provider,
wherein the third data includes a website address associated with the third content provider and a fifth timestamp;
receiving from the data provider a third content including third details originally published by the third content provider and tagged with a timestamp that matches the fifth timestamp; and
including the third content including corresponding tags in the account.

11. The computer-implemented method of claim 8, further comprising:
receiving from a second router third data regarding communication with the first content provider,
wherein the third data includes the device ID, a website address associated with the first content provider, and a fifth timestamp;
receiving from the data provider a third content including third details originally published by the first content provider and tagged with a timestamp matching the fifth timestamp; and
including the third content including corresponding tags in the account.

12. The computer-implemented method of claim 8, further comprising generating a report of social media contents stored in accounts in the database by physical locations or by device IDs.

13. The computer-implemented method of claim 8, further comprising:
correlating physical location tags with portions of the details included in the account or other tags of the details included in the account; and
generating a report for the account indicating social activity trends related to physical locations based on the correlating result.

14. The computer-implemented method of claim 2, further comprising:
receiving from the first router or an external provider information regarding a second physical location of the first router; and
tagging the first details with the second physical location.

15. The computer-implemented method of claim 14, further comprising assigning a first confidence score to the first physical location and a second confidence score to the second physical location with which the first details are tagged.

16. The computer-implemented method of claim 3, wherein the first data corresponds to a first device, the method further comprising:
receiving from the first router a time range in which the first device is connected to the first router;
receiving from the data provider a third content including third details tagged with the first user ID a timestamp within the time range, but no physical location; and
tagging the third details with the specific physical location.

17. The computer-implemented method of claim 3, further comprising
estimating a distribution of delays from when a communication is transmitted by a device for publication on a website to when the communication is published on the website,
wherein determining whether the first timestamp matches the third timestamp or whether the second timestamp matches the fourth timestamp is based on the estimated distribution.

18. The computer-implemented method of claim 2, wherein the first router is a wireless router.

19. The computer-implemented method of claim 2, wherein the first content provider or the second content provider is a social media network.

20. A system of for enhancing social media contents, comprising:
a processor and memory, cooperating to function as:
a first receiving unit configured to receive from a router for a computer network a fixed ID of a first device connected to the router, a first website address of a website associated with a content provider and visited in a first visit by the first device, and a first timestamp for the first visit, and a second website address of the website visited in a second visit by a second device connected to the router and a second timestamp for the second visit;
a second receiving unit configured to receive from a data provider a first social media content tagged with a first user ID, a timestamp matching the first timestamp, but not a physical location, and a second social media content tagged with a timestamp matching the second timestamp, and a specific physical location; and
a tagging unit configured to tag the first social media content with the specific physical location.

21. At least one tangible computer-readable medium storing instructions, which when executed by at least one data processing device, perform a method of enhancing social media contents, the method comprising:
receiving from a first router for a computer network, first data and second data regarding communication with a first content provider by one or more devices connected to the first router;
receiving from a data provider a first content including first details originally published by a second content provider that is not tagged with a physical location, and a second content including second details originally published by the second content provider that is tagged with a first physical location;
determining whether the first data matches at least in part with the first content;
determining whether the second data matches at least in part with the second content; and
when the determining results indicate matches, tagging the first details with the first physical location.
